(19) United States
(12) Patent Application Publication
(10) Pub. No.: US 2005/0220952 A1
(43) Pub. Date: Oct. 6, 2005

(54) Corn debranning machine

(75) Inventor: Peter Matthews, Houston, TX (US)

Correspondence Address: KEELING HUDSON LLC, P.O. BOX 70103, HOUSTON, TX, 77270, US

(73) Assignee: Satake USA, Inc.

(21) Appl. No.: 11/147,542

(22) Filed: Jun. 8, 2005

Related U.S. Application Data
(63) Continuation-in-part of application No. 10/004,742, filed on Dec. 4, 2001.

(51) Int. Cl. A23P 1/00

(52) U.S. Cl. 426/482

(57) ABSTRACT

The present invention provides a machine to remove the bran. The machine includes a tempering chamber for adding an amount of moisture to the bran of the corn kernel by wetting and soaking the corn kernel to expand and soften the bran and a chamber for removing substantially all bran from the corn by rubbing corn kernels together.

### CROSS-REFERENCE TO RELATED APPLICATIONS

This is a continuation-in-part of U.S. patent application Ser. No. 10/004,742.

### STATEMENT REGARDING FEDERALLY SPONSORED RESEARCH OR DEVELOPMENT

Not Applicable.

### BACKGROUND OF THE INVENTION

1. Field of the Invention

This invention relates generally to corn milling and more particularly to improved machine for debranning corn.

2. Description of the Related Art

Corn milling processes separate corn into various components of the kernel. In a wet-milling process, the corn is steeped in an aqueous solution to soften the kernel and ground to free the germ. Aqueous processes are described in U.S. Pat. No. 5,073,201 to Gisfeldt et al. In a dry-milling process, the corn kernel is separated into the endosperm, germ and other fibers (referred to as a hull or bran layer) in a dry or slightly moistened condition.

One of the necessary steps in the dry corn milling process, whether the milled product is to be used for the production of ethanol, starch, flakes, grits or flour, involves separation of the bran and the germ (also referred to as embryo) from the endosperm, which is then processed further to produce the milled corn product.

In a typical dry milling process, corn kernels are cleaned to remove extraneous material. The cleaned corn is tempered with water or steam then passed through a degerminating mill to release the bran from the germ and endosperm.

Traditionally, germ has been removed from corn kernels during milling through the use of a “Beall” type degerminator. In the Beall type of degerminator, corn is fed into and through the annulus formed between a rotating, conical rotor and a stationary concentric screen made of perforated metal. Both rotor and screen are textured with large nodes, which impede motion of the kernels as they turn with the rotor. A weighted discharge plate provides a method of controlling pressure and corn density within the chamber. In this process, the germ is dislodged from the endosperm by impact and bending stress as the kernels move through the annulus. In practice, most of the kernels are broken during the process. Typically, this process produces an effective recovery of endosperm particles of which approximately twenty to thirty percent of the endosperm pieces will be retained on a No. 6 standard sieve cloth. Because a significant portion of the bran may still adhere to the pieces of endosperm after the degermination process, further refinement of the endosperm may be required to reduce the fiber content of the endosperm product.

Inherent inefficiencies in refining and recovery processes result in increased processing costs and a reduction in the overall yield of low fat corn products.

For any of the milled corn products, the production of low fat products is desirable. In general, it is desirable during the degermination stage of the corn milling process to produce large particles of endosperm that are largely free of bran and germ. Though the degermination process can be destructive to the corn kernels, it is generally desirable to minimize the production of fine particles of endosperm, as the fine particles are difficult to separate from the bran and germ particles in order to recover them as a corn product. Maximizing the production of large particles of endosperm thus offers maximum yields of corn products and improves the quality of the products.

U.S. Pat. No. 5,250,313 to Giguere (a continuation-in-part of U.S. Pat. No. 4,189,503) describes a degerminating process wherein the corn kernels are crushed from the thin edges toward the center while avoiding crushing of the relatively flat side surfaces. The crushing force fractures the endosperm under and around the germ and squeezes the germ away from the endosperm. A machine for carrying out the degermination includes relatively rotating discs having corrugations in their facing surfaces in which the kernels are caught and crushed from the thin edges toward the center. An alternative degerminator machine includes a single rotating disc having curved guide vanes on its upper surface for guiding the kernels as they are propelled outwardly by centrifugal force.

U.S. Pat. No. 6,254,914 describes a wet-milling process for recovery of corn coarse fiber (pericarp) including the steps of: soaking corn in water to loosen the attachments of various corn components therein to each other, degerminating the soaked corn to strip the corn coarse fiber and the germ away from the endosperm, recovering the germ, and recovering the corn coarse fiber by flotation. The degerminating step of such process involves grinding the kernels in a degermination mill such as a Bauer mill so that the pericarp and germ are stripped away from the endosperm.

U.S. Pat. No. 4,181,748 to Chwalek, et al. describes a combined dry-wet milling process for refining corn comprising dry milling corn kernels to provide an endosperm fraction, a germ fraction, a fiber (hull) fraction and a cleanings fraction, wet milling the endosperm fraction including using two distinct steeping steps, one upstream and the other downstream of an impact milling step, to provide a mill starch slurry. The process further comprises removing fine fiber tailings from the mill starch slurry, separating the slurry into a starch-rich fraction and protein-rich fraction, concentrating the protein-rich fraction, directly combining the fiber (hull), cleanings, fine fiber tailings and protein-rich concentrate without removing corn oil therefrom, with the germ fraction to provide a wet animal feed product, and drying the feed product.

U.S. Pat. No. 4,301,183 to Giesfeldt et al. discloses a method and apparatus for degerminating a corn kernel by impelling the kernels along a guide vane into an impact surface including a horizontal disc having a plurality of guide vanes extending in a curvilinear path with each vane terminating in an end portion that is substantially parallel to a tangent to the disc. A plurality of impact surfaces are provided in the same horizontal plane as the disc with each surface being substantially linear and extending transversely of the path of travel of a kernel impelled by the disc.

The prior art processes and machines result in a high percentage of fine particles of endosperm that are difficult to separate from the bran and germ particles in order to recover them as a corn product.

Cylindrical, rubberized rollers have been used to remove hulls from other grains, particularly rice. Rollers for removing hulls from grains are described in U.S. Pat. No. 3,104,692 to Davis et al. dated Sep. 24, 1963, U.S. Pat. No. 4,066,012 to Satake and U.S. Pat. No. 5,678,477 to Satake et al. Despite the use of such rollers for removing hulls from grains and the long-standing need to separate corn germ from endosperm with a minimum amount of fine endosperm particles, the use of rubberized rollers and the process of the present invention have not been previously practiced.

### BRIEF SUMMARY OF THE INVENTION

Accordingly, it is an object of the present invention to provide a machine for use in process for increasing the production of large particles of bran and thus maximize yields of low-fat corn products and improve the value of the products.

The present invention provides a machine to remove the bran from the corn kernel. The apparatus has a tempering chamber to soften and expand the bran and a chamber to induce rubbing between adjacent corn kernels to remove bran. The apparatus is intended for use in a process which includes a tempering step comprising adding an amount of moisture to the bran of the corn kernel by wetting and soaking the corn kernel; a bran removal step for removing substantially all bran from the corn by rubbing corn kernels together; a second tempering step comprising adding an additional amount of moisture to the germ by wetting and soaking the exposed germ; and a degermination step to fracture the endosperm about the germ, substantially freeing the germ from the endosperm while maintaining large particle of endosperm and germ.

### BRIEF DESCRIPTION OF THE DRAWINGS

FIG. 1 depicts a schematic diagram of a debranning and degermination process incorporating the process of the present invention.

FIG. 2 depicts a cross-sectional top view of a corn kernel with the bran in place.

FIG. 3 depicts a front view of a corn kernel with the bran removed.

FIG. 4 depicts a side view of a corn kernel with the bran removed.

FIG. 5. depicts the debranning apparatus.

FIG. 6 depicts the roller portion of the degermination apparatus.

### DETAILED DESCRIPTION OF THE INVENTION

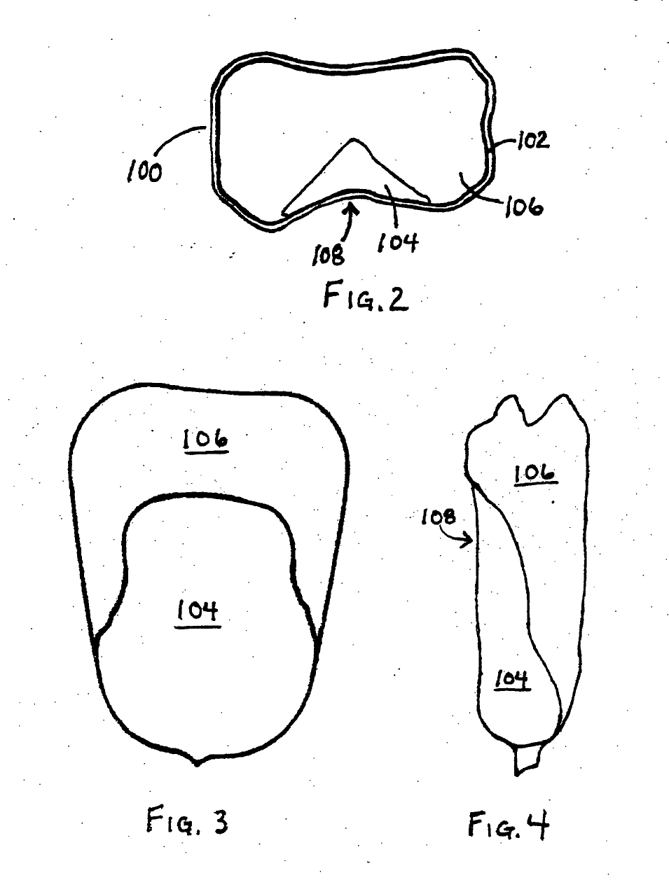

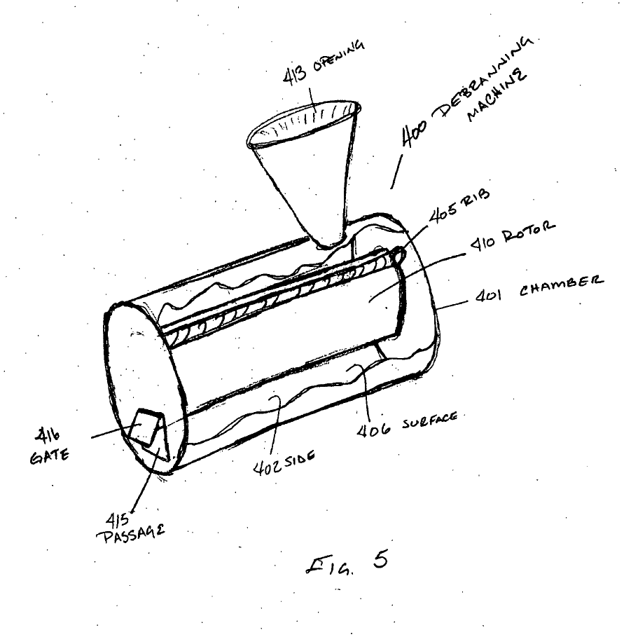

Referring first to FIGS. 2, 3, and 4 a corn kernel 100 is depicted for reference as to terms used herein. A typical corn kernel 100 includes a germ 104 and an endosperm 106 that are totally covered in a casing of bran 102. The germ 104 is embedded in one of the large, relatively flat sides 108 of kernel 100.

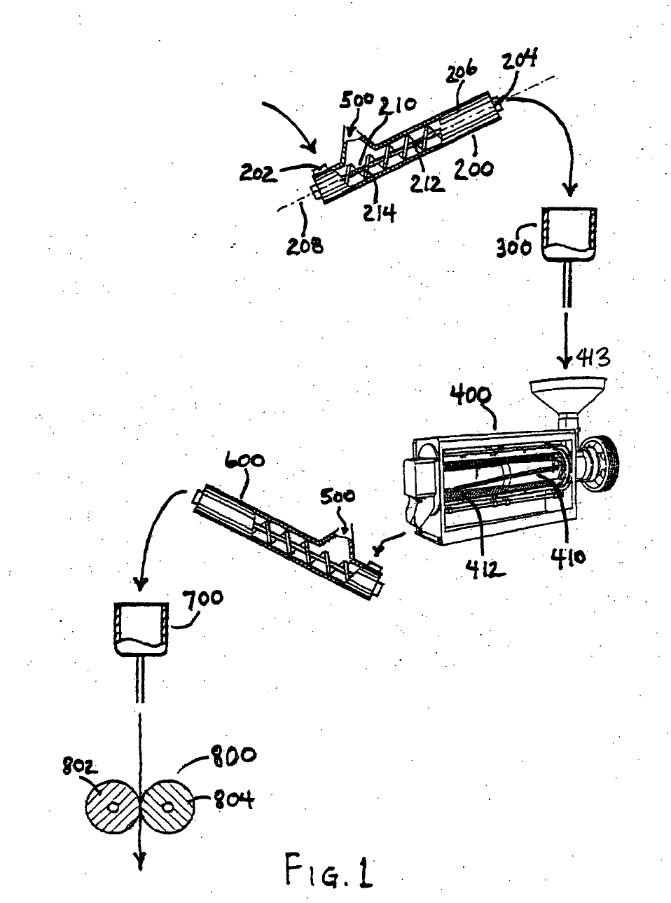

Referring to FIG. 1, the apparatus of the present invention is depicted in a process flow diagram. In the present invention a measured amount of raw, clean corn kernels are first tempered. Such tempering is well-known in the art. In the preferred embodiment, the corn kernels are first introduced into a first tempering machine 200 where a measured amount of water 500 is added. The water 500 may be in various forms including water, steam or an aqueous solution. In the preferred embodiment, the first tempering machine 200 comprises a generally cylindrical housing 206 having a central axis 208 and a co-axial auger 210. The auger 210 comprises a rotating shaft 212 having angled paddles 214, the angled paddles 214 transmitting the corn kernels (not shown) from a inlet end 202 of the tempering machine 200 to a outlet end 204 of the first tempering machine 200. The rotating auger 210 disturbs the water 500 on the corn kernels for complete wetting of the corn kernels to provide for even penetration of moisture.

Tempering machines 200 are commonly used in the industry to provide uniform wetting of corn kernels. A suitable, commercially available tempering machine is manufactured and sold by the Satake Corporation and identified as a Technovator, model STMA. The corn kernels are then transferred to a holding tank 300 where they are retained until the kernels obtain a desired level of moisture absorption, a process referred to as tempering. This tempering softens and expands the bran 102, but does not last so long as to provide significant penetration of water 500 in the germ 104 or endosperm 106. Such moisturization makes the bran 102 more pliable, and weakens the bond between the wetted bran 102 and the less-absorbent germ 104 and endosperm 106, allowing the bran to be removed without substantially disturbing the germ 104 or the endosperm 106.

Holding time in the holding tank 300 is typically three (3) to fifteen (15) minutes, depending on the variety of corn and the desired level of moisturization. In an exemplary embodiment the corn kernels are handled in a first-in, first-out basis and adding about 5% water by weight is sufficient moisturization. The invention allows for a varied range of moisture levels as needed in the resulting products for optimizing intended further processing.

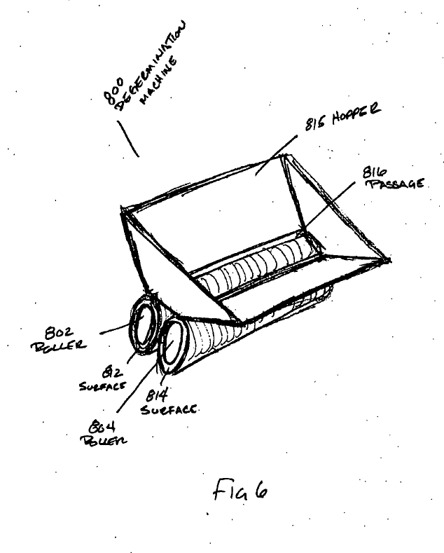

Referring to FIG. 5, debranning machine 400 (tempering chamber not shown) contains a debranning chamber 401 wherein the corn kernels are induced to rub against each other. The debranning chamber 401 where rubbing is induced includes at least one side 402. Rubbing between corn kernels is induced over sufficient time and with sufficient force to cause substantially all bran to separate from the endosperm of the corn kernel. Sufficient force may be imparted to the corn kernels by compression within debranning chamber 401. Rubbing may be caused by imparting movement to the corn kernels by oscillation of the debranning chamber or by movement of the corn kernels within the debranning chamber. Such oscillations within the debranning chamber may be accomplished by use of direction of low frequencies sound waves into the corn or by induced movement of the corn kernels within debranning chamber 401 by one or more agitators. In the preferred embodiment the debranning machine consists of a rotating cylindrical rotor 410, having a surface 406 having one or more compression-inducing surface protuberances 405 surrounded by abrasive side 402, side 402 composed of 5 or more equilateral panels, wherein the corn kernels are introduced through an opening 413. Surface protuberances 405 may be longitudinal to the surface and parallel to the axis of rotating cylindrical rotor 410 or may be skewed to the axis of rotating cylindrical rotor 410 along surface 406. Successive introduction of corn kernels generally moves previously introduced corn kernels toward passage 415, which permits exiting of debranned corn kernels. Passage 415 may be hingely gated by a gate 416 adjusted to permit exiting of debranned corn kernels upon application of sufficient force exerted on gate 416 by corn kernels within machine 400. The extent of debranning may be controlled by adjustment of the force necessary to open gate 416. In operation, as the clearance between the side 402 and the rotor 410 changes during each rotation, the corn kernels experience sufficient compression to produce an effective rubbing action which removes the bran from the corn kernel. Additionally, in the preferred embodiment, side 402 is composed of six equilateral panels which, by virtue of the non-circular shape, create concentrations of the compression and well as areas in which corn kernels are not in compression. The rate of debranning may also be adjusted by selection of the coefficient of friction associated with side 402. Faster debranning may be accomplished by use of a side 402 with a higher coefficient of friction. In the preferred embodiment, shown in FIG. 1, side 402 may be perforated to permit loose bran to exit debranning chamber 401 through perforations 412 in side 402 by gravity or by atmospheric flow. In such embodiment, the remove loose bran is of a small surface area, typically referred to as fines. Larger loose bran, typically referred to as coarse, is typically removed downstream of the debranning machine.

The foregoing disclosure and description of the invention is illustrative and explanatory thereof. Various changes in the details of the illustrated process may be made within the scope of the appended claims without departing from the spirit of the invention. The present invention should only be limited by the following claims and their legal equivalents.

1. A machine for debranning corn kernels, said corn kernels each having bran, comprising:
a tempering chamber, said tempering chamber communicating with a supply of said corn kernels, said tempering chamber communicating with a supply of water, said tempering chamber providing contact between said corn kernels and said supply of water, said tempering chamber having a corn kernel outlet;
a debranning chamber, said debranning chamber having at least one side, said chamber communicating with said tempering chamber, said debranning chamber having a a corn kernel inlet, said corn kernel inlet of said debranning chamber being in communication with said corn kernel outlet of said tempering chamber;
said corn kernels within said debranning chamber being cyclically in compression; and
an agitator, said agitator located within said debranning chamber, said agitator inducing rubbing between adjacent corn kernels.

2. The machine for debranning corn kernels of claim 1, wherein:
said at least one side of said debranning chamber having an abrasive surface;
said agitator being a rotor coaxial to said debranning chamber, said rotor having a surface;
said agitator having at least one protuberances on said surface of said rotor, said protuberances inducing compression in said corn kernels;

3. The machine for debranning corn kernels of claim 2, wherein:
said debranning chamber having a first end and a second end;
said debranning chamber communicating with said source of said corn kernels at an inlet located as said first end of said debranning chamber;
said debranning chamber having an opening for discharge of said corn kernels from said debranning chamber, said opening for discharge located at said second end of said debranning chamber;

4. The machine for debranning corn kernels of claim 3 wherein:
a gate hingedly attached to said debranning chamber at said opening for discharge of said corn kernels, said gate retaining said corn kernels within said debranning chamber, said gate tensioned to open upon application of sufficient force by said corn kernels on said gate hingedly attached to said debranning chamber.

5. The machine for debranning corn kernels of claim 4 wherein:
said rotor having at least one orifice, said orifice located tangential to said surface of said rotor, said orifice communicating with a gas supply, said orifice permitting gas flow radially to said rotor;
said at least one side of said debranning chamber having orifices, said orifices sized to permit passage of small bran particles;
said debranning chamber located within a container, said container retaining said small bran particles passing through said perforations of said at least one side of said debranning chamber.

6. The machine for debranning corn kernels of claim 5 wherein:
said at least one side of said side of said debranning chamber being composed of at least 5 equilateral panels.
